(19) United States
(12) Patent Application Publication
(10) Pub. No.: US 2008/0131844 A1
(43) Pub. Date: Jun. 5, 2008

(54) Training Toothbrush having a Pivoting Brush Head

(76) Inventor: Kenneth Taylor, Dayton, IN (US)

Correspondence Address: DUNLAP CODDING & ROGERS, P.C., PO BOX 16370, OKLAHOMA CITY, OK, 73113, US

(21) Appl. No.: 11/939,346

(22) Filed: Nov. 13, 2007

Related U.S. Application Data
(60) Provisional application No. 60/865,774, filed on Nov. 14, 2006.

(51) Int. Cl. A61C 17/00; A61C 17/22; A46B 9/04

(52) U.S. Cl. 433/216; 15/22.1; 15/167.1

(57) ABSTRACT

A training toothbrush for children comprising a body portion that includes a head portion, a handle, and a brush assembly that is configured to engage with and pivot upon the body portion. A camming mechanism, such as an oblique or curvilinear channel that receives a tracking element, is disposed between the brush assembly and the body portion and configured such that when the operator grasps the handle and attempts to brush the teeth in a longitudinal back and forth motion, the relative longitudinal movement between the handle and the brush assembly causes the camming mechanism to translate the longitudinal motion to the brush head, which then pivots vertically against the teeth in a more preferred motion for allowing the bristles to clean between teeth. In one embodiment, the apparatus includes a locking mechanism that releasably engages the brush head to prevent it from pivoting vertically so that it operates much like a standard toothbrush.

### CROSS-REFERENCE TO RELATED APPLICATIONS

This application claims priority to a provisional application Ser. No. 60/865,774 filed on Nov. 14, 2006.

### TECHNICAL FIELD

This invention relates to dental hygiene devices, more particularly to manually powered mechanical toothbrushes.

### BACKGROUND OF THE INVENTION

Early training to teach the proper technique of brushing is important for proper dental hygiene. Children especially tend to use a horizontal motion when brushing teeth when research has shown the vertical brushing is more effective in dislodging food particles between teeth. What is needed is a simple, manually operated toothbrush that can be effective in providing the benefits of vertical brush strokes, even when the user attempts to brush using a horizontal motion.

### SUMMARY OF THE INVENTION

The foregoing problems are solved and a technical advance is achieved in an illustrative brushing apparatus, such as a manually powered mechanical toothbrush, that comprises a brush assembly that includes a brush head that movably engages a body portion that includes a head portion distally and a handle extending proximally. The brushing apparatus comprises a camming mechanism, such as a track system that comprises at least one channel having a first and a second end that receives a tracking element. Relative movement between the brush assembly and the body portion causes the tracking element to ride within the channel, which is non-linear with respect to the longitudinal axis of the apparatus, thereby causing the brush head to advantageously pivot vertically from a first position to a second position that is vertically angled from the first, such as when the user attempts to employ a horizontal brushing motion against the surfaces of the teeth.

In one aspect of the present invention, the brush assembly further includes a mounting element that receives the brush head such that the brush head is pivotable thereabout. The mounting element slidable engages the head portion of the apparatus, such as within a pair of longitudinal slots or rails situated on opposite sides of a recessed area beneath the head portion. The channel of the tracking mechanism is located about the underneath of the head portion with a corresponding tracking element being disposed on the upper portion, the channel being oriented at an angle relative to longitudinal axis of the body portion such that when the tracking element rides within the channel from the first end to the second end thereof, the brush head pivots from a first position of an angled orientation to a second position of an opposite orientation.

In another aspect of the invention, the tracking element, such a pin or other type of projecting structure, is located underneath the head portion and the channel is located on the upper portion of the brush head. The channel can be configured to extend obliquely therealong such that it lies at an angle relative to the longitudinal axis of the brush head. Alternatively, the channel may extend generally parallel to the longitudinal axis, but is non-linear in that the groove of the channel is formed at an angle relative to the upper surface of the upper portion of the brush head. The groove comprises a ‘spiral’ configuration such that it is reoriented to a configuration perpendicular to the upper surface toward the center of the channel, again assuming an angle toward the second end of the channel that generally mirrors the angle of the groove at the first end. The helical configuration of the groove thus causing the brush head to pivot during longitudinal movement of the brush assembly. This channel configuration may also be used such that the channel is located underneath the head portion and the tracking element is located on the upper portion of the brush head.

In yet another aspect of the invention, the brush head directly engages the head portion via tracking elements (e.g., side projections, rails, etc.) located laterally on either side of the upper portion of the brush head. The head portion of the apparatus includes a track area that includes two curvilinear channels of either of the types described above (obliquely angled channel or spiral groove) and located on either side of the track area. The first and second channels are configured to so that they force the brush head to pivot to the first angled position when the brush head is located at one end of the channel, and pivot to the second angled position when the brush head moves toward the opposite end of the channel, returning to the first position when the brushing apparatus is moved in an opposite direction relative to the teeth, the pivoting motion of the brush head providing an effective vertical motion for cleaning teeth.

In still yet another aspect of the invention, the head portion and the handle of the body portion comprise separate elements that slide relative to one another during horizontal brushing operation to actuate the camming mechanism and cause the brush head to pivot vertically. In one embodiment, the brush head is directly mounted to the head portion and configured to pivot vertically thereabout. The tracking element is disposed on the brush head and engages the angled channel located on the handle, which is slidably received by the head portion as the apparatus is used in a horizontal brushing motion. As the tracking element traverses the channel during longitudinal movement, causing the brush head to deflect and pivot as the track element moves from one end of the channel to the other and back.

In still yet another aspect of the invention, the apparatus includes a locking mechanism, such as a sliding knob the handle connected to an internal rod, that is actuated to engage the brush assembly and the limit the vertical or pivoting movement thereof, thereby allowing the apparatus to used like a standard non-pivoting toothbrush. As the rod or other structure is advanced toward the head portion to engage with and/or wedge between components, the brush head is immobilized until it is released to again allow the brush head to pivot via longitudinal action of the apparatus body portion.

### BRIEF DESCRIPTION OF THE DRAWING

Embodiments of the present invention will now be described by way of example with reference to the accompanying drawings, in which:

FIG. 1 depicts an exploded view of the illustrative embodiment of the present invention;

FIG. 2 depicts an underside view of embodiment of FIG. 1 showing the brush assembly in the first longitudinal position;

FIG. 3 depicts a cross-sectional view taken along line 3-3 of FIG. 2;

FIG. 4 depicts an underside view of embodiment of FIG. 1 showing the brush assembly in the second longitudinal position;

FIG. 5 depicts a cross-sectional view taken along line 5-5 of FIG. 4;

FIG. 6 depicts a split and top view of a second embodiment of the present invention;

FIG. 7 depicts a top view of a third embodiment of a brush assembly of the present invention;

FIG. 8 depicts a partially sectioned side view of an embodiment of the present invention that includes the brush assembly of FIG. 7;

FIG. 9 depicts an exploded view of a fourth embodiment of the present invention.

FIG. 10 depicts a cross-sectional side view of the present invention that includes a locking mechanism to immobilize the brush head; and

FIG. 11 depicts an detail view of terminus of the locking mechanism of FIG. 10.

### DETAILED DESCRIPTION

For the purposes of promoting an understanding of the principles of the invention, reference will now be made to the embodiments illustrated in the drawings, and specific language will be used to describe the same. It should nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. Any other undisclosed or incidental details of the construction or composition of the various elements of the disclosed embodiment of the present invention are not believed to be critical to the achievement of the advantages of the present invention, so long as the elements possess the attributes needed for them to perform as disclosed. The selection of these and other details of construction are believed to be well within the ability of one of even rudimentary skills in this area, in view of the present disclosure. The invention encompasses embodiments both comprising and consisting of the elements described with reference to the illustrative embodiments. Unless otherwise indicated, all ordinary words and terms used herein shall take their customary meaning as defined in The New Shorter Oxford English Dictionary, 1993 edition. All technical terms shall take on their customary meaning as established by the appropriate technical discipline utilized by those normally skilled in that particular art area. It is therefore intended that the foregoing detailed description be regarded as illustrative rather than limiting, and that it be understood that it is the following claims, including all equivalents, that are intended to define the spirit and scope of this invention.

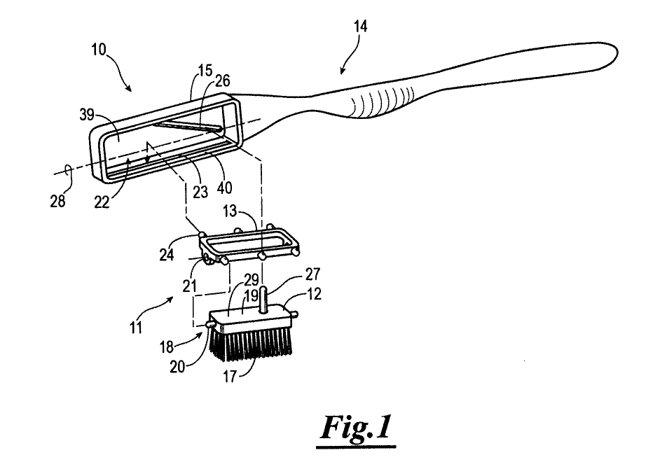

The present invention, as embodied in FIGS. 1-10, comprises a brushing apparatus 10 that is configured such that the brush assembly 11, comprising a brush head 12 with bristles 17 extending from the face 18 thereof, is longitudinally slidable relative to the body portion 14 of the apparatus that comprises a head portion 15 distally and a handle 16 extending proximally—either fixedly or movably connected thereto, the head portion being operatively and mechanically coupled to the brush assembly via a camming mechanism, such as a track system 25 that when engaged, causes the brush head to pivot relative to the head portion 15 of the apparatus as the brush assembly is caused to move longitudinally from a first position 33 relative to the body portion 14 to a second position 34, such as when a horizontal brushing action is utilized to clean the teeth.

Now referring to the specific embodiment depicted in FIGS. 1-5, the brush assembly comprises a brush head 12 of a type similar to that found in a standard toothbrush, the brush head 12 comprising a face portion 18 from which a plurality of cleaning bristles 17 (typically nylon) extend, and a upper portion 19, typically comprising hard plastic, from which a pin or peg-like tracking element 27 or follower, the first component of the track system 25, extends vertically. The tracking element 27 can be integrally formed with the upper portion 19 or comprise a separate element, such as a metal pin embedded therein. The tracking element 27 is configured to insert into and ride within the recessed channel 26 the second component of the track system, located on the underside 39 of track region 22 of the head portion 15 in which the brush assembly 11 slidably engages (FIGS. 1,3, and 5). The channel 26, which is lies at an angle relative to the longitudinal axis 28 of brushing apparatus 10, extends between a first end 31, located proximally, and a second end 32, oriented distally. In the illustrative embodiment, a bracket-like mounting element 13 pivotably receives the brush head via a pair of pivot points that include peg-like projections 20 extending from either end of the of the mounting element that slidably insert into apertures 21 at both ends of the mounting element. The mounting element 13 further includes slot-engaging structure 24, such as the illustrative lateral projections, that insert into the pair of slots 23 or other track structure located on either side 40 of the track area 22 under the head portion 15 (alternatively, the slots can be located in the brush head instead). The mounting element 13 therefore is able to slide longitudinally within the track area 22 beneath the head portion 15 in either direction depending on the direction of the brush stroke. It should be noted that the head portion can comprise a region of the body portion 14 that is integral with the handle 14, as depicted, or the head portion or body portion can comprise an assembly of components, such as a separate element that houses the channel.

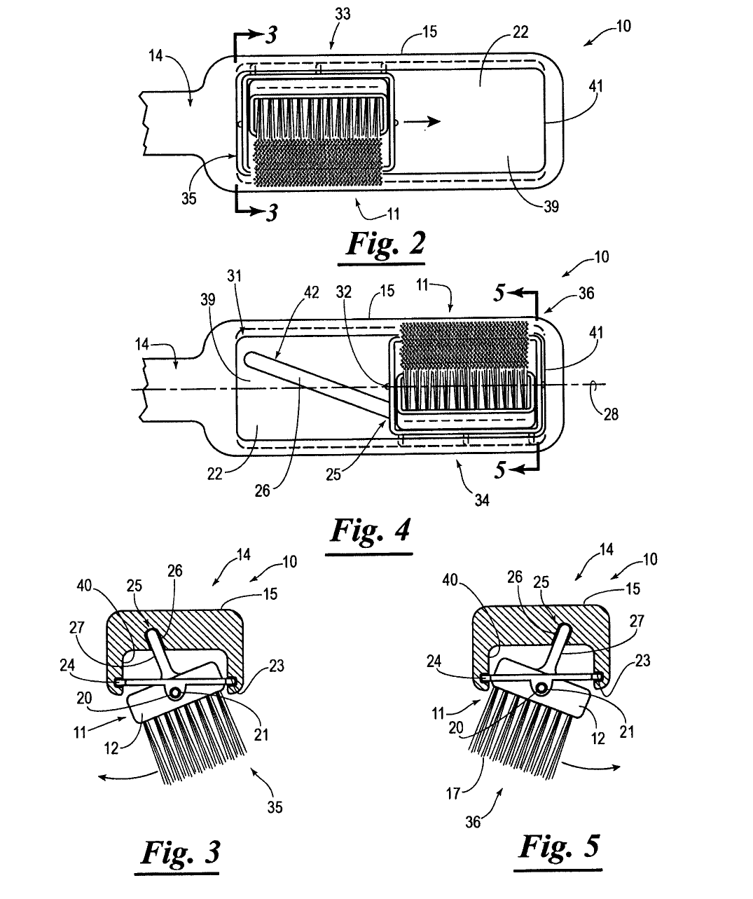

The vertical sweeping motion of the pivoting brush head is caused by a camming action supplied by the track system due to the oblique orientation of the channel relative to the direction of movement of the brush assembly against the head portion in the illustrative embodiment. When the brush assembly 11 is located at the first, proximal position 33 (oriented toward the handle 16), the tracking element 27, located toward the proximal end of the brush head 25, resides at the first end 31 of the channel. As shown in FIGS. 1 and 4, the channel 26 is oriented at an angle with respect to the longitudinal axis 28 of the apparatus 10 such that the tracking element 27 is deflected at an angle respect to the underneath surface 39 of the head portion 15, as well as the mounting element 13 (FIGS. 2-3). The first angled orientation of the brush head 12 is preferably 30 to 75 degrees from perpendicular, rather than being perpendicular to the head portion 15 as in a typical toothbrush. As the operator employs a horizontal brushing motion, the mounting element 13 of the brush assembly 11 slides within both the side slots 23 toward the distal end 41 of the head portion 15 (FIG. 4). The tracking element 27 rides within the oblique channel and the brush head 12 assumes a perpendicular orientation as the tracking element 27 reaches the center 42 of the channel. Further longitudinal movement of the tracking element 27 within the oblique channel 26 causes the brush head 25 to deflect at a second angled configuration 36 (FIG. 4-5), generally mirroring the first angled configuration as the tracking element 27 reaches the second end 32 of the channel with the brush assembly 11 being at the second, distal position 34 within the track area 22 of the head portion (FIG. 4). When the brush assembly 11 is urged in the opposite direction, the action is reversed and the brush head 12 returns to the first angled configuration. Thus, during a rapid series of horizontal brush strokes, the brush head 12 will repeatedly scrub the surface of the teeth in a desired vertical motion, despite the lack of an accompanying vertical brushing action supplied by the operator.

FIGS. 7-8 depicted an alternative embodiment of the present invention in which the channel 26 extends parallel with the longitudinal axis 28 of the brush assembly 11; however, the recessed groove 30 of the channel comprises a ‘spiral’ configuration in which the groove is angled relative to the upper surface 29 of the upper portion 19 and away from the channel opening at the first end 31 thereof. The groove 30 then rotates to a perpendicular orientation about the center 42 of the channel 26 before continuing to spiral to a angled configuration at the second end 32 of the channel, the angle being generally a mirror opposite to the groove's orientation about the first end 31 of the channel. As depicted in FIG. 8, the tracking element 27 is configured to ride within the channel 26 to cause the brush head to pivot during longitudinal movement of the brush assembly 11 relative to the head portion 15 is located on the underneath side 39 of the head portion within the track area 22.

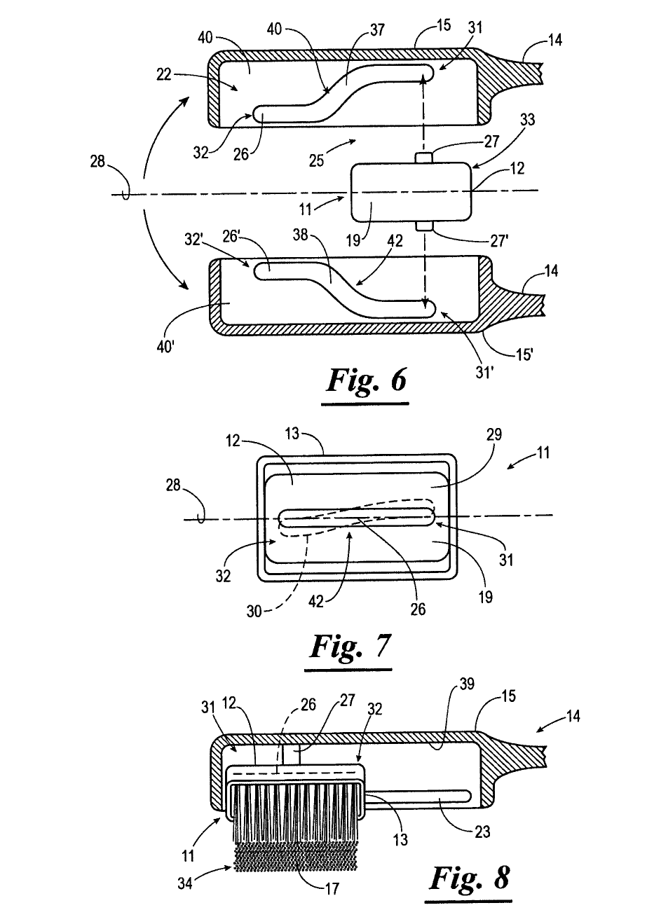

The track system can comprise an alternative configuration in which it is the brush head 12 that engages the head portion 15 of the brushing apparatus such that the brush assembly 11 does not require a mounting element 13 to facilitate the longitudinal movement and allow the brush head to pivot in response to the camming action of the track system 25. As depicted in FIG. 6 in which the two halves of the apparatus 10 are shown laid open about the brush head 15, the brush head comprises a pair of tracking elements 27,27′ located on either side of the upper portion 19 and extending laterally to engage a pair of channels 26,26′ comprising a first curvilinear channel 37 located on one side portion 40 of the track area 22 of the underneath portion 39 of the head portion 15, and a second curvilinear channel 38 located on the opposite side portion 40′ thereof. The first and second curvilinear channels 37,38 are configured such that when the brush head 15 is at the first longitudinal position 33 about the first end 31 of channel 26, the first tracking element 27 that engages the first curvilinear channel 37 is oriented upward while the second tracking element 27′ resides within the second curvilinear channel 38 such that it is oriented downward, thus causing the brush head to assume an angled configuration to the left (as viewed from above). As brushing action causes the brush head 15 to move distally within respect to the body portion 14, the brush head reorients with the opposite curvilinear channels 37,38, first assuming a level orientation as the tracking elements reach the center 42 of the channel, then assuming an second angled configuration at the second end 32 of the channel, the second angle being a mirror opposite of that when the brush head is at the first end 31 of the channel (deflecting to the right when viewed from above). The pivoting action is similar to that shown in FIGS. 2-5 which depict the brush head 15 assumes first and second angles 35,36 in response to longitudinal movement, thereby creating a vertical brushing motion.

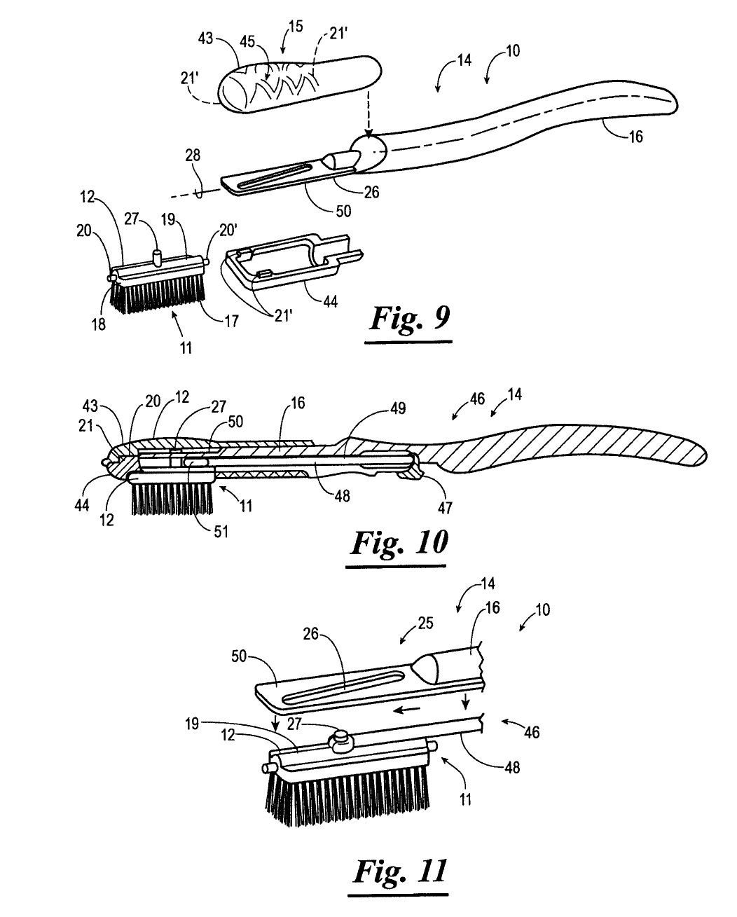

Another embodiment is shown in FIG. 9 in which the head portion 15 and the handle 16 of the body portion comprises separate elements that slidable engage one another during the operation of the brushing apparatus 10. The brush assembly 11 does not include a mounting element 13, such as depicted in FIG. 1, but rather the mounting pegs 20,20′ of the brush head 12 are received by the pivot points 21,21′ of the head portion 15 so that the brush head is held thereby and pivots therein, without moving longitudinally relative to the head portion as in the previous embodiments depicted. The camming mechanism 25 comprises a channel 26 disposed on the handle and oriented obliquely to its longitudinal axis 28, and a peg-like tracking element 27 located on the upper surface 29 of the brush head 12. The distal portion 50 of the handle 16 comprising the channel 26 is flattened and inserts into the head portion 15, which in the illustrative embodiment, comprises an upper portion 43 and a bottom portion 44 that mate with one another (by being snapped or bonded together) to receive and encase the distal end of the handle. A flange or otherwise structure on the distal portion 50 of the handle can further assist in preventing egress from the head portion 15 or the peg 26 being held within the channel 27 can supply the primary means to retain the head portion over the handle and prevent it from disconnecting. The channel 26 in the illustrative embodiment completely traverses the handle, but could alternatively comprise a recess in the underneath surface thereof. During operation of the apparatus 10, the head portion 15 is maintained generally stationary within the mouth, in part with the assistance of an optional illustrative textured surface 45 on the upper surface of the head portion 15 that allows the head portion to be held against the inside of the mouth cavity. As the operator utilizes a horizontal brushing motion, the handle slides further into the recessed underside area of the head portion 15 into which the brush head 12 is pivotably mounted. The tracking element 27, which is shown generally disposed within the center of the brush head 12, moves relative to the advancing channel 26 that diverges obliquely from the longitudinal axis 28 of the apparatus 10, thereby forcing the brush head to pivot left or right at an angle similar to that shown in either FIG. 3 or FIG. 5, depending on the orientation of the channel. As the motion of the handle 16 is reversed relative to the head portion 15 and brush head 12, the retreating oblique channel 26 reorients the brush head back to a centered position before then causing the brush head to pivot in the opposite vertical direction as the tracking element 27 travels toward the opposite end of the channel and diverges from the longitudinal axis 28 in the reverse direction. Therefore, a horizontal back and forth brushing motion applied to the handle will cause the brush head to pivot up and down in synchrony with the perpendicular horizontal motion. As with some of the earlier embodiments, the track system 25 can also be reversed so that the tracking element 27 is disposed on the underside of the handle and traverses an obliquely oriented channel that is disposed on the upper surface 29 of the brush head 12.

In a variation of the embodiment of FIG. 9, the brush head can be affixed to the head portion instead pivotably mounted, while the camming mechanism between the handle and the head portion 16/brush head 12 is configured such that as the handle is inserted thereinto, the entire head portion assembly that include the brush head pivots thereabout. This can be done by including a track that wraps around the exterior of the handle or the interior of the head portion assembly with the tracking mechanism riding therealong, or some other means familiar to a skilled artisan. Compression or tension springs may be affixed between the components to assist in the return of the handle from within the head portion assembly or perform the camming action to pivot the head portion and/or brush head. In fact, one skilled in the art would appreciate the variety of available camming mechanism suitable to accomplish the task of translating longitudinal movement of the handle to the brush head to cause the latter to pivot vertically about an axis, and which would fall within the spirit of the present invention.

A optional feature applicable to each of the embodiments of FIGS. 1-9 in depicted in FIG. 10 comprising a locking mechanism 46 that can convert the pivoting brushing apparatus of the present invention into one that essentially operates as a standard toothbrush, if so desired, such as when a vertical or other specific brushing motion is necessary. The illustrative locking mechanism 46 comprises a knob 47 that is operatively connected to a slidable rod 48 disposed within an internal channel 49 located within the body of the handle 16. As the knob is advanced distally, the attached rod advances to engage the brush assembly 11 and prevent it from pivoting vertically when the apparatus 10 is applied to brush the teeth using a horizontal motion. One illustrative means to accomplish the locking engagement is depicted in FIG. 11, wherein the distal end 51 of the rod is configured to releasably capture the track system 25 when advanced and thus, maintain the brush head 12 in the centered (non-angled) position relative to the handle. Withdrawing the rod 48 via the knob releases the tracking element 27 so that the brush head 12 is free to pivot. A skilled artisan would readily appreciate the many alternative structures applicable to affect locking of the brush head and prevent vertical movement, such as by inserting the rod into a slot or space within the brush head to immobilize it, wedging the rod between components to limit movement, or by use of other structures such as sleeves, levers, pins, etc., that can be advanced or otherwise actuated to engage and secure otherwise movable structure. These alternative means may or may not include an external actuating knob or lever of the type depicted.

What is claimed is:

1. A manually powered brushing apparatus for cleaning the surfaces of teeth, comprising:
a brush assembly comprising a brush head having a face and an upper portion, the face including a plurality of bristle elements extending therefrom;
a body portion having a longitudinal axis and further comprising a head portion and a handle extending proximally therefrom, the brush assembly operatively engaging at least one of the head portion and the handle; and
wherein the body portion and the brush assembly of the brushing apparatus further are interconnected via a camming mechanism such when the brushing apparatus is operated using a horizontal brushing motion against the teeth, relative longitudinal movement between the brush assembly and the body portion actuates the camming mechanism, resulting in the brush head being caused to pivot vertically between a first angled configuration and a second angled configuration.

2. The brushing apparatus of claim 1, wherein the head portion is configured to slidably receive the brush assembly such that the brush assembly moves longitudinally relative to the body portion when the brushing apparatus is operated using the horizontal brushing motion against the teeth.

3. The brushing apparatus of claim 2, wherein the brush assembly further comprises a mounting element configured to receive the brush head and engage the body portion and be longitudinally slidable relative thereto, the brush head being pivotable within the mounting element in response to longitudinal movement thereof relative to the body portion.

4. The brushing apparatus of claim 1, wherein the head portion is slidably engaged to the handle of the body portion, the brush head being pivotably received within the head portion; the track system being configured such that the brush head slidably engages the handle, resulting in the brush head moving between the first and the second angled configuration as the handle is caused to slide longitudinally relative to the head portion.

5. The brushing apparatus of claim 1, wherein the camming mechanism comprises a track system that include a channel disposed on one of the brush assembly and body portion and a tracking element located on the other of the brush assembly and the body portion.

6. The brushing apparatus of claim 5, wherein the track system comprises at least a first channel having a first end and a second end, the channel located about one of the head portion and the brush head and a first tracking element located about other of the head portion and the brush head; the tracking element movable between the first end and the second end of the channel.

7. The brushing apparatus of claim 6, wherein the track system is configured such the first channel is located within a track area located beneath the head portion.

8. The brushing apparatus of claim 6, wherein the track system further includes a second channel and second tracking element, the first and second channels located within the recessed, the first and second tracking elements being disposed on upper portion of the brush head and configured such that they engage the first and second channels respectively, the first and second channels being configured to cause the brush to pivot from the first position to the second position as the brush assembly moves longitudinally relative to the body portion.

9. The brushing apparatus of claim 5, wherein the track system is configured such that the channel is located about the upper portion of the brush head and the tracking element is located about an area located beneath the head portion.

10. The brushing apparatus of claim 5, wherein the channel extends along the brushing apparatus at an oblique angle relative to the longitudinal axis of the body portion.

11. The brushing apparatus of claim 5, wherein the channel comprises a curvilinear configuration.

12. The brushing apparatus of claim 1, wherein the camming mechanism operatively connects the handle to the brush assembly, the handle being configured to move relative to the head portion, thereby causing the brush head to pivot vertically.

13. The brushing apparatus of claim 1, wherein the brushing apparatus comprises a releasably locking mechanism that when actuated, prevents the brush head from pivoting relative to the body portion.

14. A manually powered brushing apparatus for cleaning the surfaces of teeth, comprising:
a brush assembly comprising a brush head having a plurality of bristle elements extending therefrom;
a handle portion slidably engaged with brush assembly, the brushing apparatus further comprising a track system disposed thereon and configured such that when the brushing apparatus is operated using a horizontal brushing motion against the teeth, the engagement of the track system translates the longitudinal movement of the handle to cause the brush head to pivot vertically against the surfaces of the teeth.

15. The brushing apparatus of claim 14, wherein the track system comprises a channel disposed on one of the handle and the brush assembly and a tracking element disposed on the other of either the handle or brush assembly, the channel being oriented and configured that as the tracking element traverses longitudinal therein, the brush head is deflected vertically to pivot about the brush head.

16. The brushing apparatus of claim 14, wherein the brushing apparatus further comprises a head portion that pivotably receives the brush assembly.

17. The brushing apparatus of claim 14, wherein the head portion is slidably engaged to the handle and moves relative thereto to actuate the track system during the horizontal brushing motion by the operator.

18. The brushing apparatus of claim 14, wherein the track system comprises a channel disposed in oblique orientation within the handle and a tracking element disposed on the brush head opposite the surface comprising the plurality of bristles.

19. The brushing apparatus of claim 14, wherein the brushing apparatus comprises a releasably locking mechanism that when actuated, prevents the brush head from pivoting relative to the body portion.

20. A method of brushing teeth, comprising the steps of:
providing a manually powered brushing apparatus having a brush assembly comprising a vertically pivotable brush head, a body portion configured to engage the brush assembly, and a camming mechanism operatively connecting the brush assembly and a component of the body portion that is slidably engaged to thereto;
grasping the body portion;
applying the brush head against the teeth while the brushing apparatus is in a horizontal orientation; and
moving the body portion longitudinally back and forth against the teeth such that the body portion is caused to slide longitudinally relative to the brush assembly, resulting in the camming mechanism translating the longitudinal motion of the body portion so that the brush head is caused to pivot vertically against the teeth.
